(19) United States
(12) Patent Application Publication
(10) Pub. No.: US 2020/0329690 A1
(43) Pub. Date: Oct. 22, 2020

(54) UNMANNED AERIAL VEHICLE

(71) Applicant: BASF Agro Trademarks GmbH, Ludwigshafen am Rein (DE)

(72) Inventors: Andrew Charles CHAPPLE, Leverkusen (DE); Malcolm FAERS, Düsseldorf (DE)

(21) Appl. No.: 16/764,015

(22) PCT Filed: Nov. 12, 2018
(86) PCT No.: PCT/EP2018/080894

§ 371 Date: May 14, 2020

(30) Foreign Application Priority Data
Nov. 21, 2017 (EP) 17202769.0

(51) Int. Cl. A01M 7/00; B64C 39/02; B64D 1/18

(52) U.S. Cl. CPC A01M 7/0042; B64C 39/024; B64D 1/18; B64C 2201/14; B64C 2201/108; B64C 2201/12; B64C 2201/027

(57) ABSTRACT

The present invention relates to an unmanned aerial vehicle (10) for spraying an agricultural field. The UAV has a liquid reservoir (20), a liquid spray gun (30), and a plurality of sets of rotor blades (40). The liquid spray gun has a spray axis extending away from the liquid spray gun. Each one of the plurality of sets of rotor blades is connected to a corresponding one of a plurality of drive shafts (50). A first drive shaft (51) of the plurality of drive shafts has a first drive axis extending longitudinally through the first drive shaft that is configured to be at a first angle to the spray axis. A second drive shaft (52) of the plurality of drive shafts has a second drive axis extending longitudinally through the second drive shaft that is configured to be at a second angle to the spray axis. The first drive axis and second drive axis are located in substantially the same first-second plane. The first angle extends away from the spray axis in a first direction and the second angle extends away from the spray axis in a second direction. The first direction is different to the second direction The liquid product ejected from the spray gun is at least partially entrained by a downwash of air from a first set of rotor blades connected to the first drive shaft and by a downwash of air from a second set of rotor blades connected to the second drive shaft.

### FIELD OF THE INVENTION

The present invention relates to an unmanned aerial vehicle for spraying an agricultural field.

### BACKGROUND OF THE INVENTION

The general background of this invention is the application of active ingredients in liquid form to foliage, being applied by vehicles using for example boom sprayers. Active ingredients, such as herbicides, pesticides, insecticides and nutritional supplements, are required to be applied in agricultural environments. Controlling weeds, insects and diseases in crops is an important requirement for reducing losses in agriculture. This is commonly achieved by foliar spray of crops by spray application from tractors, back-pack sprayers and unmanned aerial vehicles (UAV) such as drones and radio controlled helicopters. UAVs are increasingly being used, but the width of crop being sprayed with the active ingredient has a limited width, and application of the active ingredient to the crop can vary during an application run, within and between swaths.

### SUMMARY OF THE INVENTION

It would be advantageous to have improved means of applying active ingredients in agricultural environments using UAVs.

The object of the present invention is solved with the subject matter of the independent claims, wherein further embodiments are incorporated in the dependent claims.

According to an aspect, there is provided an unmanned aerial vehicle for spraying an agricultural field, comprising:
a liquid reservoir;
a liquid spray gun; and
a plurality of sets of rotor blades.

The liquid reservoir is configured to hold a liquid product to be applied to an agricultural field. The liquid spray gun is in liquid communication with the liquid reservoir, and is configured to spray the liquid product to apply the liquid product to the agricultural field. The liquid spray gun has a spray axis extending away from the liquid spray gun, such that when the liquid product is ejected from the spray gun, it is initially substantially centered around the spray axis. Each one of the plurality of sets of rotor blades is connected to a corresponding one of a plurality of drive shafts. A first drive shaft of the plurality of drive shafts has a first drive axis extending longitudinally through the first drive shaft that is configured to be at a first angle to the spray axis. A second drive shaft of the plurality of drive shafts has a second drive axis extending longitudinally through the second drive shaft that is configured to be at a second angle to the spray axis. The first drive axis and the second drive axis are located in substantially the same first-second plane. The first angle extends away from the spray axis in a first direction and the second angle extends away from the spray axis in a second direction. The first direction is different to the second direction. This means that when the UAV is operating the liquid product ejected from the spray gun is at least partially entrained by a downwash of air from a first set of rotor blades of the plurality of rotor blades connected to the first drive shaft and at least partially entrained by a downwash of air from a second set of rotor blades of the plurality of rotor blades connected to the second drive shaft.

In other words, counter-intuitively two sets of rotor blades of a UAV are positioned at an angle such that the downwash of air is not directed vertically downwards when the UAV is in a normal operating configuration and as such the rotor blades are not as efficient as they could be for lift purposes. However, the downwashes of air are located either side of the liquid spray ejected from a spray gun of the UAV and are directed outwards and in this way the spray from the spray gun can be entrained or contained by the angled downwashes from the two sets of angled rotor blades. Consequently, there is an increased swath of the spray droplets hitting the crop and the active ingredient in the liquid product can be more effectively and efficiently applied to the crop in the field. To put this another way, rather than a column of spray descending upon the crop as is the case for a normal UAV spraying a crop and with spray outside of the column of air produced by rotors settling towards the ground under the influence of gravity that can be susceptible to drifting away from where it is required, with the described UAV a cone (or truncated or elliptical cone) of spray is entrained within the angled downwashes of air, enabling more crop to be accurately sprayed per pass of the UAV and as the spray is entrained the effects of spray drift are also mitigated.

In an example, a magnitude of the first angle is equal to a magnitude of the second angle.

In other words, the angling of the rotors can be symmetric about the spray axis, but need not be. For example if the first and second sets of rotors are situated to the sides of the UAV and there is a side wind, then the rotor blades can be angled appropriately to account for the side wind, resulting in an area below the UAV continuing to be sprayed.

In an example, the spray axis is located in substantially the first-second plane.

In an example, a fore-aft plane extends in a fore aft direction of the unmanned vehicle and wherein the spray axis is located in the fore-aft plane, and wherein the first drive shaft is located to one side of the fore-aft plane and the second drive axis is located on the opposite side of the fore-aft plane.

To put this another way, the two angle sets of rotor blades are located to either side of the UAV with respect to a forward direction, and in this way the spray can be better entrained or contained.

In an example, the first-second plane is oriented perpendicularly to the fore-aft plane.

In other words, the angled rotor blades are positioned either side of the UAV situated backwards from the front of the UAV by the same distance on either side. In this manner, the spray is further better entrained through such a symmetrical configuration.

In an example, a bisecting plane is oriented perpendicularly to the first-second plane and wherein the spray axis is located in the bisecting plane. A third drive shaft of the plurality of drive shafts is located in the bisecting plane at a location laterally displaced from the spray gun. This means that when the UAV is operating the liquid product ejected from the spray gun is at least partially entrained by a downwash of air from a third set of rotor blades of the plurality of rotor blades connected to the third drive shaft.

In other words, two angled rotors are situated either side of the spray gun, and a third rotor is situated on another side of the spray gun. In this way, the spray from the spray gun is further entrained and contained by angled downwashes from two sides and on a third side by a spatially offset downwash of air. In this manner, in addition to further entraining and containing the spray the third rotor can be used to provide additional lift when required, for example when the liquid reservoir is full of liquid.

In an example, the third drive shaft has a third axis extending longitudinally through the third drive shaft that is configured to be at a third angle to the spray axis.

In this manner, as well as being laterally displaced the downwash from the third set of rotor blades is angled thus providing for an increased area of crop being sprayed.

In an example, a fourth drive shaft of the plurality of drive shafts is located in the bisecting plane at a location spatially displaced from the spray gun on the opposite side of the spray gun to the third drive shaft. Thus, when the UAV is operating the liquid product ejected from the spray gun is at least partially entrained by a downwash of air from a fourth set of rotor blades of the plurality of rotor blades connected to the fourth drive shaft.

In an example, the fourth drive shaft has a fourth axis extending longitudinally through the fourth drive shaft that is configured to be at a fourth angle to the spray axis.

In an example, a further one or two drive shafts of the plurality of drive shafts are positioned at a lateral distance from the spray gun that is greater than the lateral distances of the first and second drive shafts from the spray gun.

In this way, one or both of the further drive shaft(s) and associated sets of rotors can be primarily be used for lift, and for turning of the UAV and/or counteracting side winds and can vary the lift they produce as the UAV becomes lighter. Thus, at least two sets of rotor blades, and possible three sets or four sets of rotor blades can be considered to be “delivery” rotor blades, and are used to deliver the liquid product to the crop. These rotors can operate in the same manner as the UAV becomes lighter as the liquid product is sprayed and can do so, because one or more sets of rotor blades, which can be considered to be “assist” rotor blades can be primarily used for lift and turning, etc. The lift produced by the assist rotors combines with the lift produced by the delivery rotors to keep the UAV airborne. However, the delivery rotors provide a continuously constant amount of lift, thereby providing the liquid product to the crop in a continuous manner, and do so even as the UAV becomes lighter, because the assist rotors can gradual decrease the lift they produce as the UAV becomes lighter such that the total lift produced continues to match the UAV weight.

In an example, a controller of the unmanned aerial vehicle is configured to control the plurality of sets of rotor blades to generate a lift force that matches the weight of the unmanned aerial vehicle. The controller is configured to control at least one of the plurality of sets of rotor blades other than the sets of rotor blades connected to the first and second drive shafts as the weight of the varies to vary the lift force as the liquid product is applied to the agricultural field.

In other words, the first and second rotor blades can operate in a continuously uniform manner as the UAV sprays a field, providing a uniform downdraught that entrains and contains the spray droplets and that drives the spray droplets into foliage of the crop in a uniform manner. However, as the UAV sprays the field it necessarily becomes lighter as the liquid product is sprayed, but the angled rotors can operate in the same manner with the reduction in required lift being realised through the control of at least another set of rotor blades that then operates in a continuously less lift generating manner as the UAV becomes ever lighter. Additionally, control of the plurality of sets of rotor blades in this way enables the UAV to maintain its height above a crop canopy during spraying, during which the mass of the UAV varies as the liquid product is applied, and during which air movement due to local winds can have vertical components as well as horizontal components. Thus, the control of the plurality of sets of rotor blades can maintain a height of the UAV mitigating the effect of changes in mass and vertical wind movements, and enable the UAV to maintain its correct lateral position mitigating the effects of cross winds and crops that are planted in perfectly straight lines.

In an example, the controller is configured to control at least one of the plurality of sets of rotor blades other than the sets of rotor blades connected to the third drive shaft as the weight of the varies to vary the lift force as the liquid product is applied to the agricultural field.

In an example, the controller is configured to control at least one of the plurality of sets of rotor blades other than the sets of rotor blades connected to the third and fourth drive shafts as the weight of the UAV varies so as to vary the lift force as the liquid product is applied to the agricultural field.

In an example, the controller is configured to control the sets of rotor blades connected to the first and second drive shafts as a function of the liquid product being applied.

In an example, the controller is configured to control the sets of rotor blades connected to the first and second drive shafts as a function of a configuration of the liquid spray gun.

In an example, the controller is configured to control the sets of rotor blades connected to the first and second drive shafts as a function of a crop in the agricultural field.

In an example, the controller is configured to control the sets of rotor blades connected to the first and second and third drive shafts as a function of the liquid product being applied.

In an example, the controller is configured to control the sets of rotor blades connected to the first and second and third drive shafts as a function of the configuration of the liquid spray gun.

In an example, the controller is configured to control the sets of rotor blades connected to the first and second and third drive shafts as a function of the crop in the agricultural field.

In an example, the controller is configured to control the sets of rotor blades connected to the first and second and third and fourth drive shafts as a function of the liquid product being applied.

In an example, the controller is configured to control the sets of rotor blades connected to the first and second and third and fourth drive shafts as a function of the configuration of the liquid spray gun.

In an example, the controller is configured to control the sets of rotor blades connected to the first and second and third and fourth drive shafts as a function of the crop in the agricultural field.

In this manner, different liquids being sprayed could have different droplet sizes and need to be entrained and contained in different ways, and specific liquid may need to be driven into a crop in different ways to other liquids. For example, one type of active ingredient may need to be applied over the whole plant whilst a second type of active ingredient need only be sprayed on the topmost leaves of the plant. In this case, a greater downwash can be produced in the former, with respect to the latter, to entrain the droplets and at the same time force the droplets into most of the plant.

In an example, the controller is configured to control the magnitudes of the first and second angles as a function of the liquid product being applied.

In an example, the controller is configured to control the magnitudes of the first and second angles as a function of a configuration of the liquid spray gun.

In an example, the controller is configured to control the magnitudes of the first and second angles as a function of a crop in the agricultural field.

In an example, the controller is configured to control the first and second and third drive angles as a function of the liquid product being applied.

In an example, the controller is configured to control the first and second and third drive angles as a function of the configuration of the liquid spray gun.

In an example, the controller is configured to control the first and second and third drive angles as a function of the crop in the agricultural field.

In an example, the controller is configured to control the first and second and third and fourth drive angles as a function of the liquid product being applied.

In an example, the controller is configured to control the first and second and third and fourth drive angles as a function of the configuration of the liquid spray gun.

In an example, the controller is configured to control the first and second and third and fourth drive angles as a function of the crop in the agricultural field.

In this way, the entraining and constraining effect of the downwashes can be varied as required, and also the effects of side winds can be mitigated.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic set up of an example of an unmanned aerial vehicle for spraying an agricultural field;

FIG. 2 shows a schematic set up of a rear view of an example of an unmanned aerial vehicle for spraying an agricultural field;

FIG. 3 shows a schematic set up of a side view of the example of the unmanned aerial vehicle for spraying an agricultural field;

FIG. 4 shows a schematic set up of a rear view of an example of an unmanned aerial vehicle for spraying an agricultural field;

FIG. 5 shows a schematic set up of a side view of the example of the unmanned aerial vehicle for spraying an agricultural field;

FIG. 6 shows a schematic set up of a rear view of an example of an unmanned aerial vehicle for spraying an agricultural field;

FIG. 7 shows a schematic set up of a rear view of an example of an unmanned aerial vehicle for spraying an agricultural field; and

FIG. 8 shows a schematic set up of a side view of the example of the unmanned aerial vehicle for spraying an agricultural field shown in FIG. 7.

### DETAILED DESCRIPTION OF EMBODIMENTS

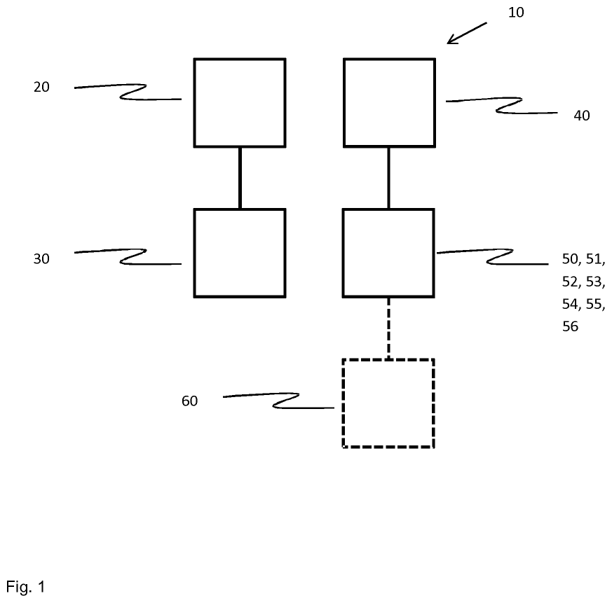

FIG. 1 shows an example of an unmanned aerial vehicle 10 for spraying an agricultural field. The unmanned aerial vehicle (UAV) 10 comprises a liquid reservoir 20, a liquid spray gun 30, and a plurality of sets of rotor blades 40. The liquid reservoir 20 is configured to hold a liquid product to be applied to an agricultural field. The liquid spray gun 30 is in liquid communication with the liquid reservoir 20, and is configured to spray the liquid product to apply the liquid product to the agricultural field. The liquid spray gun 30 has a spray axis extending away from the liquid spray gun, such that the liquid product ejected from the spray gun is initially substantially centered around the spray axis. Each one of the plurality of sets of rotor blades is connected to a corresponding one of a plurality of drive shafts 50. A first drive shaft 51 of the plurality of drive shafts 50 has a first drive axis extending longitudinally through the first drive shaft that is configured to be at a first angle to the spray axis. A second drive shaft 52 of the plurality of drive shafts 50 has a second drive axis extending longitudinally through the second drive shaft that is configured to be at a second angle to the spray axis. The first drive axis and the second drive axis are located in substantially the same first-second plane. The first angle extends away from the spray axis in a first direction and the second angle extends away from the spray axis in a second direction. The first direction is different to the second direction, such that the liquid product ejected from the spray gun is at least partially entrained by a downwash of air from a first set of rotor blades of the plurality of rotor blades connected to the first drive shaft and by a downwash of air from a second set of rotor blades of the plurality of rotor blades connected to the second drive shaft.

In an example, the liquid spray gun is moveable with respect to a body of the UAV.

In an example, the first drive shaft is moveable with respect to the body of the UAV to position the first drive axis at the first angle.

In an example, the second drive shaft is moveable with respect to the body of the UAV to position the second drive axis at the second angle.

According to an example, a magnitude of the first angle is equal to a magnitude of the second angle.

According to an example, the spray axis is located in substantially the first-second plane. second plane.

According to an example, a fore-aft plane extends in a fore-aft direction of the unmanned aerial vehicle, and the spray axis is located in the fore-aft plane. The first drive shaft is located to one side of the fore-aft plane and the second drive axis is located on the opposite side of the fore-aft plane.

According to an example, the first-second plane is oriented perpendicularly to the fore-aft plane.

According to an example, a bisecting plane is oriented perpendicularly to the first-second plane and wherein the spray axis is located in the bisecting plane. A third drive shaft 53 of the plurality of drive shafts 50 is located in the bisecting plane at a location laterally displaced from the spray gun, such that the liquid product ejected from the spray gun is at least partially entrained by a downwash of air from a third set of rotor blades of the plurality of rotor blades connected to the third drive shaft.

In an example, the bisecting plane is the fore-aft plane.

According to an example, the third drive shaft has a third axis extending longitudinally through the third drive shaft that is configured to be at a third angle to the spray axis.

In an example, the magnitude of the third angle is greater than the magnitude of the first angle and greater than the magnitude of the second angle.

In an example, the third drive shaft is moveable with respect to the body of the UAV to position the third drive axis at the third angle.

Thus, in addition to helping to entrain the sprayed liquid, the third set of rotor blades mounted on the third drive shaft can be used for lift purposes and also used to turn the UAV or mitigate the effects of a side wind.

According to an example, a fourth drive shaft 54 of the plurality of drive shafts 50 is located in the bisecting plane at a location spatially displaced from the spray gun on the opposite side of the spray gun to the third drive shaft. The positioning is such that the liquid product ejected from the spray gun is at least partially entrained by a downwash of air from a fourth set of rotor blades of the plurality of rotor blades connected to the fourth drive shaft.

According to an example, the fourth drive shaft has a fourth axis extending longitudinally through the fourth drive shaft that is configured to be at a fourth angle to the spray axis.

In an example, the magnitude of the fourth angle is greater than the magnitude of the first angle and greater than the magnitude of the second angle. Thus, in this way an “elliptical” entraining downwash of air can be provided around the sprayed liquid, which can be oriented with the long axis of the ellipse in the fore-aft axis of the UAV, or oriented with the long axis perpendicular to the fore-aft axis. In this way, drift of the spray droplets is mitigated and the spray per unit time can be deposited within a carefully controlled “footprint” and in this way a correct and known amount of active ingredient can be applied to the crop, in addition to the area of crop sprayed per pass of the UAV being increased.

In an example, the third angle extends away from the spray axis in a third direction and the fourth angle extends away from the spray axis in a fourth direction, wherein the third direction is different to the fourth direction.

In an example, the fourth drive shaft is moveable with respect to the body of the UAV to position the fourth drive axis at the fourth angle.

Thus, in addition to helping to entrain the sprayed liquid along with the first, second and third sets of rotors, the fourth set of rotor blades mounted on the fourth drive shaft can be used for lift purposes and also used to turn the UAV or mitigate the effects of a side wind, and can be used in concert with the third set of rotor blades to this effect.

According to an example, a further one or two drive shafts 55, 56 of the plurality of drive shafts 50 are positioned at a lateral distance from the spray gun that is greater than the lateral distances of the first and second drive shafts from the spray gun.

In an example, when there are two further drive shaft the two further drive shafts are located on opposite sides of the spray gun to each other.

In an example, the two further drive shafts are the third and fourth drive shafts. In an example, the two further drive shafts are in addition to the third and fourth drive shafts.

According to an example, a controller 60 of the unmanned aerial vehicle is configured to control the plurality of sets of rotor blades to generate a lift force that matches the weight of the unmanned aerial vehicle. The controller 60 is configured to control at least one of the plurality of sets of rotor blades other than the sets of rotor blades connected to the first and second drive shafts as the weight of the varies to vary the lift force as the liquid product is applied to the agricultural field.

According to an example, the controller is configured to control at least one of the plurality of sets of rotor blades other than the sets of rotor blades connected to the third drive shaft as the weight of the varies to vary the lift force as the liquid product is applied to the agricultural field.

According to an example, the controller is configured to control at least one of the plurality of sets of rotor blades other than the sets of rotor blades connected to the third and fourth drive shafts as the weight of the varies to vary the lift force as the liquid product is applied to the agricultural field.

According to an example, the controller is configured to control the sets of rotor blades connected to the first and second drive shafts as a function of the liquid product being applied and/or as a function of a configuration of the liquid spray gun and/or as a function of a crop in the agricultural field; or wherein the controller is configured to control the sets of rotor blades connected to the first and second and third drive shafts as a function of the liquid product being applied and/or as a function of the configuration of the liquid spray gun and/or as a function of the crop in the agricultural field; or wherein the controller is configured to control the sets of rotor blades connected to the first and second and third and fourth drive shafts as a function of the liquid product being applied and/or as a function of the configuration of the liquid spray gun and/or as a function of the crop in the agricultural field.

According to an example, the controller is configured to control the magnitudes of the first and second angles as a function of the liquid product being applied and/or as a function of a configuration of the liquid spray gun and/or as a function of a crop in the agricultural field; or wherein the controller is configured to control the first and second and third drive angles as a function of the liquid product being applied and/or as a function of the configuration of the liquid spray gun and/or as a function of the crop in the agricultural field; or wherein the controller is configured to control the first and second and third and fourth drive angles as a function of the liquid product being applied and/or as a function of the configuration of the liquid spray gun and/or as a function of the crop in the agricultural field.

In an example, the controller is configured to control the orientation of spray gun with respect to the body of the UAV, and in this way if the body of the UAV tilts as a consequence of performing a turn or as a consequence of counteracting a side wind, the spray gun can tilt with respect to the body to keep pointing downwards. Also, the angled rotors can tilt at the same time, to for example maintain their angles about the spray axis which has now moved with respect to the body of the UAV.

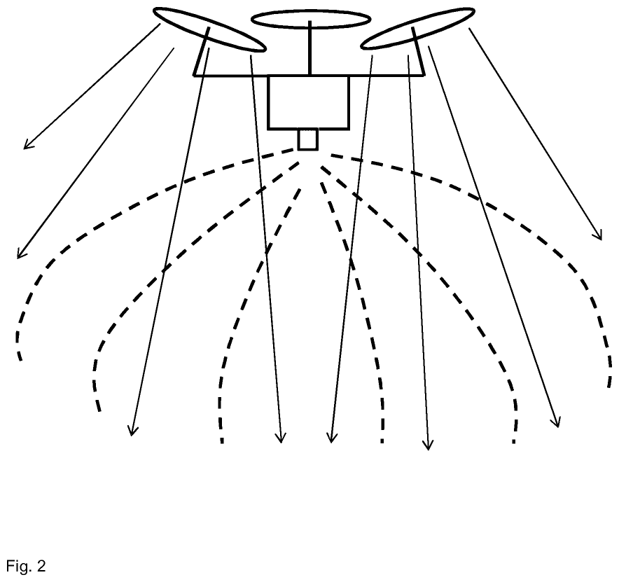

The UAV for spraying an agricultural field is now described in more detail with respect to FIGS. 2-8.

The UAV described here, is used to apply pesticidally active ingredients (a.i.s) and other products to agricultural fields for the control of weeds, insects and diseases, an important requirement for reducing yield losses in agriculture. In arable crops, this is commonly achieved by foliar spray of crops by spray application from boom sprayers, back-pack sprayers, aeroplanes and helicopters, and unmanned aerial vehicles (UAV) such as drones and radio controlled helicopters. However, using drones in agriculture has generally meant attaching a spraying device to an existing drone design, normally a pump and hydraulic nozzles to emulate the application conventionally done with a ground based sprayer or a knapsack sprayer. For a ground based boom sprayer or a knapsack sprayer, the spraying equipment can be considered separately from the machinery for moving that equipment. However, drones are closer akin to orchard and vineyard sprayers or air-assisted boom sprayers, where the spraying equipment is integrated carefully an air blast or air curtain system used to transport the spray into dense canopies (spray entrainment). Drones are different in that the airstream carrying the drops to the ground also provides the lift to the overall equipment, in the same way as a conventional aerial application.

The described UAV addresses a number of issues, as now discussed.

The mass of air moved to support a UAV will change as the payload is expended. Thus, a drone weighing 20 kg with a 10 kg payload at the beginning of a spraying operation will need approximately a third less power to maintain height at the end of the spraying operation. Thus, the airstream under the UAV will change with travel distance, and this has implications for the efficient application of the active ingredients. For example, applying a fungicide into cereals where the active ingredient is needed towards the bottom of the canopy (e.g., Septoria control), the UAV may start out with too much air being moved, driving the spray back out of the canopy where it becomes prone to drift, whereas at the end of the spray run, the air stream may be insufficient to drive the active ingredient deep enough into the canopy. The presently described UAV however addresses this problem. As discussed power requirements will change with loss of payload as the spraying operation is completed. Thus to maintain the most effective air stream over the canopy, one set of rotors deliver the ‘correct’ airflow to the canopy (the ‘delivery rotors’) while a second set, mounted outside the column of air being driven by the ‘delivery rotors’ assists in lifting the drone when payload is high (the ‘assist rotors’). The assist rotors can be mounted ahead and behind the delivery rotors to reduce any effect they may have on the swath pattern, or mounted far enough sideways that the down drafts from the rotors does not significantly affect the swath pattern.

With a conventional UAV, the airstream entraining the spray is also used for directional control of the drone, e.g. for turning, compensating for the wind direction. For example, if the UAV is running up and down a field, the swaths of spray reaching the canopy need to be parallel and contiguous. If the UAV is forced off the direct flight line by a localised change in wind speed, the UAV will direct the airflow against the direction of the wind. Fixed nozzles under the rotors or on a boom will thus be directed downwind, and not vertically down to the crop foliage. This increases the risk of drift and also means that the swaths are not parallel nor contiguous. The presently described UAV deals with this in that the assist rotors can be used to turn the drone and deal with the effect of any side wind. To do this, the rotors are able to rotate on their long axis independently of the delivery rotors. Thus, the UAV can maintain a direct flight path between two points (delivering parallel swaths) without disturbing the structure of the air entrainment for the spray and the evenness of the distribution of the active ingredient under the drone flight path.

For a conventional UAV, the mass of air under the UAV is approximately a column. Thus, from the point of view of the airstream carrying spray droplets down to the canopy, the effective swath entrained by air is only a little wider than the rotor-tip to rotor-tip distance across the UAV, whilst for the conventional UAV there can be spray outside of the column of the airstream that can drift away from where it is required. Thus, the swath is either inside the range of the rotors and very narrow (reduced workload) or is variable (relying on the rotor wash to distribute the active ingredient outside the airflow entrained by the drone's rotors). The presently described UAV deals with this by widening the swath where air entrainment takes the droplets down into the canopy. To do this, the delivery rotors are angled out so that instead of a column directly under the rotors—the most efficient way of obtaining lift—the delivery rotors use energy to change the column of air to a cone, or more effectively, an ellipse. There will be a limit on the width of the ellipse depending on the energy needed to generate it, and there will be a loss of lift. However, there will be a point where the energy needed to create the ellipse of entraining air is offset by a wider and more reliably even swath beneath the UAV (increasing work rate).

Further, with conventional spray systems used with conventional UAVs the droplet spectra of hydraulic nozzles is wide—typically 10 to 700 μm for most fine to medium agricultural nozzles. For a very commonly used −03 type nozzle, approximately 20% of the volume is in drops less than 150 μm, and considering the height at which agricultural drones are flown, is the range of droplet sizes that would constitute a risk of drift. Applications done with much larger, less drift-prone drops mean that either the drops will contain an excess of active ingredient for efficient use of that active ingredient when the drops impact foliage or the carrier volume must be large (100s of litres per ha). The presently described UAV can address this by providing a narrower distribution of drops than available from a hydraulic nozzle, that are neither too small so as to minimise spray drift nor too large to avoid either excessive payload requirements or overloading the individual drops with active ingredient. This is achieved by using spinning discs to generate a narrower droplet spectra, rather than pumps and hydraulic nozzles. If hydraulic nozzles are replaced with a device similar to the Micron Herbi applicator, then a controllable spray with very few small droplets and very few oversize droplets can be fed into the air stream generated by the delivery rotors. It is however to be noted, that such droplet size control is not necessary and the delivery and assist rotors as described above provide for the described advantages even for normal spray systems, but with the spinning disc spray system providing for additional advantages. It is to be noted that spray gun nozzle design/control can also be used to provide a reduced spread in droplet size (spectrum) and further to control the sprayed liquid in order to modify the droplet spectrum in order to obtain droplets having a required range of sizes; such control of the sprayed liquid to provide a required modified droplet spectrum can also be achieved through appropriate control of the spinning disc system as discussed above. Thus, if a reduced droplet size spectrum is required, this can be achieved in ways other than the spinning disc system example discussed above, for example, piezo-electric or electro-hydrodynamic atomisers.

Thus, the presently described UAV has a number of rotors dedicated to delivering a user-specified airstream down to the field (canopy or bare ground), each capable of being angled out from the line of flight to create an elliptical cone of air that entrains the droplets being generated under the UAV. More rotors—the assist rotors—are mounted fore and aft of the delivery rotors, or to the sides of the delivery rotors, in order to provide the extra lift required when the drone is fully laden and to allow steering of the drone as well as compensating for wind shifts, without disrupting or interfering with the cone of entraining air produced by the delivery rotors. The assist rotors are controllable and able to be moved sufficiently in several axes to allow control of the drone (slowing, turning, maintaining and changing height). Under the delivery rotors are mounted a number of Herbi-type shielded spinning discs with internal spray recycling, delivering drops of a narrow drop size spectrum, and variable width of spray angle by altering the size of the exit slot. The Herbi-type atomisers can also be set up to rotate about the short axis of the drone (perpendicular to the horizontal direction of the flight path) to either maintain swath pattern (parallel lines of applied spray) or to compensate for wind direction and speed.

Now, turning to FIGS. 2-8:

FIG. 2 shows a rear view of an example of a UAV spraying a field. Two sets of rotor blades are angled out sideways and the associated cone of air is entraining or containing the droplets of a liquid product containing an active ingredient that are being produced by a spray gun—here a spray gun can have the spinning disc droplet generation system as discussed above. The angles rotors, for a particular crop and when dispensing a particular liquid product and active ingredient, operate in the same manner driving the active ingredient into the foliage of the crop in a consistent manner even as the weight of the UAV changes, and provided that a wide swath of crop is sprayed per pass of the UAV. The UAV has an additional pair of sets of rotor blades centered along the centre fore-aft axis of the UAV. These can be used to augment the lift produced by the angled rotors, and these rotors do change the lift produced in order to match the weight of the UAV as the liquid product is applied. All of the rotors can be used for turning, and forward motion purposes, using cyclic control. However to ensure that the angled rotors operate in the same manner, in this example the rotors along the centre-line are used for turning and for changing the forward speed. This can be used via cyclic control or through the drive shafts of the rotors being moveable.

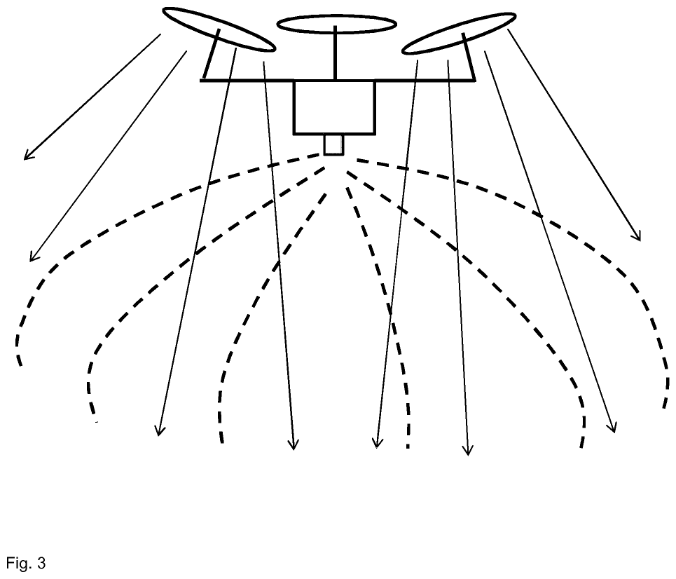

FIG. 3 shows a side view of an example of a UAV spraying a field. The UAV of FIG. 3 has the same two angled rotors as shown in FIG. 2, which are now shown as the centre rotor, but now the fore-aft rotors are also angled. The fore-aft rotors are again used for turning and changing for forward motion purposes, but by angling one of both of these rotors the spray being applied to the crop can be better controlled.

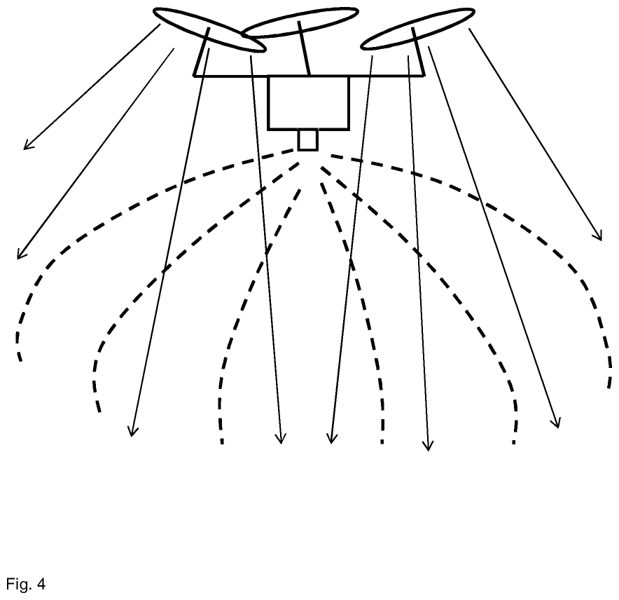

FIG. 4 shows a rear view of an example of a UAV. As described above, rather than using cyclic control to turn and change forward motion, the fore-aft rotors are mounted on moveable drive shafts, enabling the UAV to turn, which is what the UAV is doing in FIG. 4.

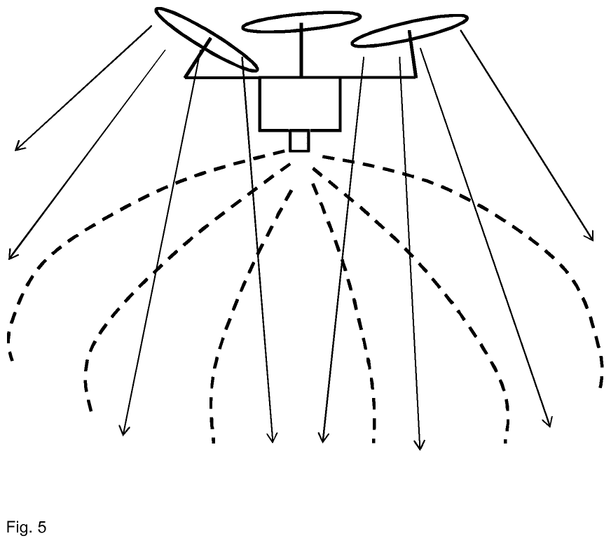

FIG. 5 shows a side view of an example of a UAV spraying a field. The UAV of FIG. 5 has the same two angled rotors and moveable rotors as shown in FIG. 4, which are now shown as the centre rotor, but now the fore-aft rotors are also angled. The fore-aft rotors are again used for turning and changing for forward motion purposes, but by angling one of both of these rotors the spray being applied to the crop can be better controlled.

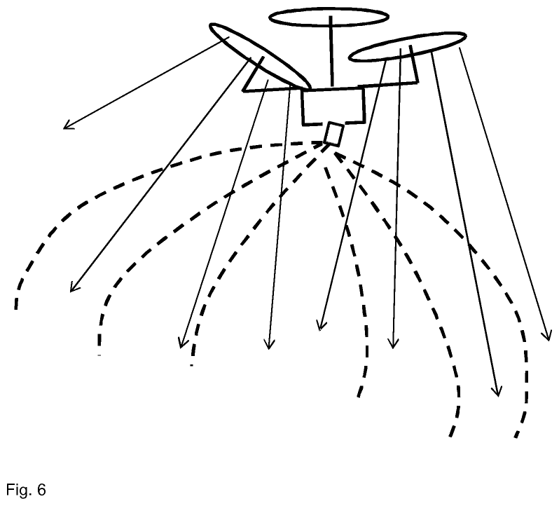

FIG. 6 shows a rear view of an example of a UAV spraying a field. The UAV is in the process of turning or counteracting a side wind, and this has resulted in the body of the UAV tilting. The spray gun has however also tilted in order to point vertically downwards, and the two sideways and outward pointing rotors have changed their angles slightly in order that the conical downwash of air surrounding entraining and containing the spray stays the same. Thus, each of these rotors maintains the same angle of “tilt” with respect to a vertical axis, but because the body of the UAV is tilted the two rotors are angled differently to the body of the UAV.

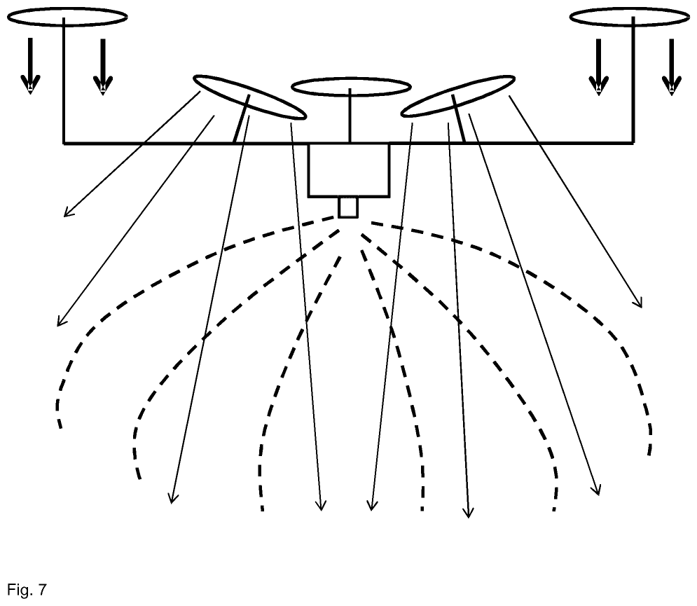

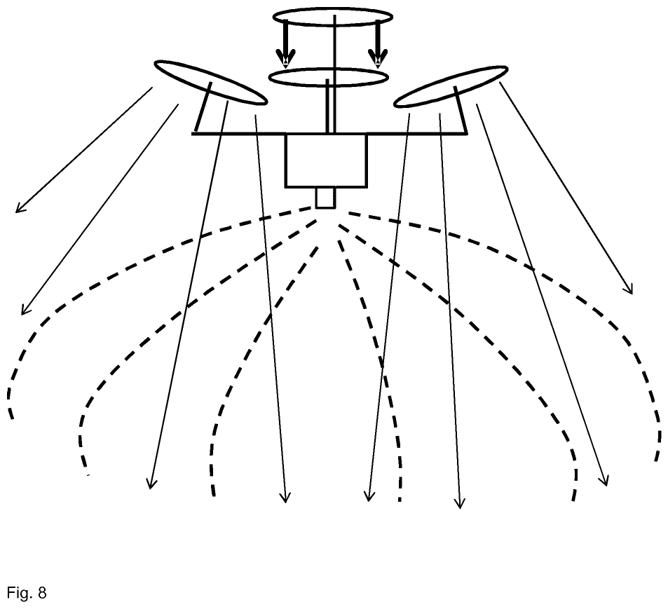

As described above, the two sideways and outward facing rotors entrain and contain the spray providing for a wider sprayed swath, with fore-aft rotors providing for controllable augmenting lift, which can also be used to control the angle of the downwash air from the UAV. The fore-aft assist rotors can be positioned at distances fore and aft that they do not interfere with the spray, but can also be positioned at a distances outboard of the angled side pointing rotors, which can aid in turning control. Indeed FIGS. 7 and 8 shows an example of such a UAV, which has four sets of rotors blades around the spray gun to control the spray, but can just have two sideways pointing rotors. Then an additional pair of rotors are positioned sideways from the rotors controlling the spray at a distance that does not interfere with the spray. These additional rotors can be positioned fore-aft and then when there are only the two angled sideways pointing rotor blades, such a UAV can be as shown in FIGS. 2 and 4 for example.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are recited in mutually different dependent claims does not indicate that a combination of these measures cannot be used to advantage. Any reference signs in the claims should not be construed as limiting the scope.

1. An unmanned aerial vehicle (10) for spraying an agricultural field, comprising:
a liquid reservoir (20);
a liquid spray gun (30); and
a plurality of sets of rotor blades (40);
wherein, the liquid reservoir is configured to hold a liquid product to be applied to an agricultural field; wherein, the liquid spray gun is in liquid communication with the liquid reservoir, and is configured to spray the liquid product to apply the liquid product to the agricultural field;
wherein, the liquid spray gun has a spray axis extending away from the liquid spray gun, such that the liquid product ejected from the spray gun is initially substantially centered around the spray axis;
wherein, each one of the plurality of sets of rotor blades is connected to a corresponding one of a plurality of drive shafts (50);
wherein, a first drive shaft (51) of the plurality of drive shafts has a first drive axis extending longitudinally through the first drive shaft that is configured to be at a first angle to the spray axis, and wherein a second drive shaft (52) of the plurality of drive shafts has a second drive axis extending longitudinally through the second drive shaft that is configured to be at a second angle to the spray axis and wherein the first drive axis and second drive axis are located in substantially the same first-second plane; and
wherein the first angle extends away from the spray axis in a first direction and the second angle extends away from the spray axis in a second direction, wherein the first direction is different to the second direction such that the liquid product ejected from the spray gun is at least partially entrained by a downwash of air from a first set of rotor blades of the plurality of rotor blades connected to the first drive shaft and by a downwash of air from a second set of rotor blades of the plurality of rotor blades connected to the second drive shaft.

2. Unmanned aerial vehicle according to claim 1, wherein a magnitude of the first angle is equal to a magnitude of the second angle.

3. Unmanned aerial vehicle according to claim 1, wherein the spray axis is located in substantially the first-second plane.

4. Unmanned aerial vehicle according to claim 1, wherein a fore-aft plane extends in a fore-aft direction of the unmanned aerial vehicle, and wherein the spray axis is located in the fore-aft plane, and wherein the first drive shaft is located to one side of the fore-aft plane and the second drive axis is located on the opposite side of the fore-aft plane.

5. Unmanned aerial vehicle according to claim 4, wherein the first-second plane is oriented perpendicularly to the fore-aft plane.

6. Unmanned aerial vehicle according to claim 1, wherein a bisecting plane is oriented perpendicularly to the first-second plane and wherein the spray axis is located in the bisecting plane and wherein a third drive shaft (53) of the plurality of drive shafts is located in the bisecting plane at a location laterally displaced from the spray gun, such that the liquid product ejected from the spray gun is at least partially entrained by a downwash of air from a third set of rotor blades of the plurality of rotor blades connected to the third drive shaft.

7. Unmanned aerial vehicle according to claim 6, wherein the third drive shaft has a third axis extending longitudinally through the third drive shaft that is configured to be at a third angle to the spray axis.

8. Unmanned aerial vehicle according to claim 6, wherein a fourth drive shaft (54) of the plurality of drive shafts is located in the bisecting plane at a location spatially displaced from the spray gun on the opposite side of the spray gun to the third drive shaft, such that the liquid product ejected from the spray gun is at least partially entrained by a downwash of air from a fourth set of rotor blades of the plurality of rotor blades connected to the fourth drive shaft.

9. Unmanned aerial vehicle according to claim 8, wherein the fourth drive shaft has a fourth axis extending longitudinally through the fourth drive shaft that is configured to be at a fourth angle to the spray axis.

10. Unmanned aerial vehicle according to claim 1, wherein a further one or two drive shafts (55, 56) of the plurality of drive shafts are positioned at a lateral distance from the spray gun that is greater than the lateral distances of the first and second drive shafts from the spray gun.

11. Unmanned aerial vehicle according to claim 1, wherein a controller (60) of the unmanned aerial vehicle is configured to control the plurality of sets of rotor blades to generate a lift force that matches the weight of the unmanned aerial vehicle, and wherein the controller is configured to control at least one of the plurality of sets of rotor blades other than the sets of rotor blades connected to the first and second drive shafts as the weight of the varies to vary the lift force as the liquid product is applied to the agricultural field.

12. Unmanned aerial vehicle according to claim 11, wherein the controller is configured to control at least one of the plurality of sets of rotor blades other than the sets of rotor blades connected to the third drive shaft as the weight of the varies to vary the lift force as the liquid product is applied to the agricultural field.

13. Unmanned aerial vehicle according to claim 11, wherein the controller is configured to control at least one of the plurality of sets of rotor blades other than the sets of rotor blades connected to the third and fourth drive shafts as the weight of the varies to vary the lift force as the liquid product is applied to the agricultural field.

14. Unmanned aerial vehicle according to claim 11, wherein the controller is configured to control the sets of rotor blades connected to the first and second drive shafts as a function of the liquid product being applied and/or as a function of a configuration of the liquid spray gun and/or as a function of a crop in the agricultural field; or wherein the controller is configured to control the sets of rotor blades connected to the first and second and third drive shafts as a function of the liquid product being applied and/or as a function of the configuration of the liquid spray gun and/or as a function of the crop in the agricultural field; or wherein the controller is configured to control the sets of rotor blades connected to the first and second and third and fourth drive shafts as a function of the liquid product being applied and/or as a function of the configuration of the liquid spray gun and/or as a function of the crop in the agricultural field.

15. Unmanned aerial vehicle according to claim 11, wherein the controller is configured to control the magnitudes of the first and second angles as a function of the liquid product being applied and/or as a function of a configuration of the liquid spray gun and/or as a function of a crop in the agricultural field; or wherein the controller is configured to control the first and second and third drive angles as a function of the liquid product being applied and/or as a function of the configuration of the liquid spray gun and/or as a function of the crop in the agricultural field; or wherein the controller is configured to control the first and second and third and fourth drive angles as a function of the liquid product being applied and/or as a function of the configuration of the liquid spray gun and/or as a function of the crop in the agricultural field.
